(19) United States
(12) Patent Application Publication
(10) Pub. No.: US 2009/0269480 A1
(43) Pub. Date: Oct. 29, 2009

(54) Supercritical Fluid Loading of Porous Medical Devices With Bioactive Agents

(75) Inventor: Joseph Berglund, Santa Rosa, CA (US)

Correspondence Address: MEDTRONIC VASCULAR, INC.;IP LEGAL DEPARTMENT, 3576 UNOCAL PLACE, SANTA ROSA, CA, 95403, US

(73) Assignee: Medtronic Vascular, Inc., Santa Rosa, CA (US)

(21) Appl. No.: 12/244,167

(22) Filed: Oct. 2, 2008

Related U.S. Application Data
(60) Provisional application No. 61/047,563, filed on Apr. 24, 2008.

(51) Int. Cl. B05D 5/00; B05D 1/02

(52) U.S. Cl. 427/2.25; 427/2.1; 427/2.24; 427/2.26; 427/2.28; 427/2.3; 427/2.31

(57) ABSTRACT

Described herein are implantable medical devices that can be coated with polymers and/or bioactive agents with the aid of supercritical fluids and methods for coating the devices. The medical devices described herein can have at least a portion of their surface made of or formed from a porous material. The supercritical fluids are used as a carrier for the bioactive agents described. Once the bioactive agents are carried to the medical device surface, they are sequestered there, preferably in the pores. The supercritical fluid is sprayed onto the medical devices achieving precipitation of the fluid. If appropriate conditions are used in the area of precipitation, bioactive agents can penetrate into the pores of the medical device before coming out of solution and expanding.

### RELATED APPLICATIONS

This application claims the benefit of U.S. Provisional Patent Application No. 61/047,563 filed Apr. 24, 2008.

### FIELD OF THE INVENTION

The present invention relates to loading bioactive agents into porous surfaces using rapid precipitation of supercritical fluids.

### BACKGROUND OF THE INVENTION

A supercritical fluid is a substance that has been subjected to conditions that are above the critical temperature and critical pressure of that substance. The supercritical region is the range of conditions that are found in the upper right-hand portion of a phase diagram, where the temperature is above the critical temperature (T_{c}) and the pressure is above the critical pressure (P_{c}). This combination of critical temperature and pressure is known as the critical point. Hence, stated another way, a substance becomes supercritical where its temperature and pressure are above its critical point (i.e., T>T_{c} and P>P_{c}).

A supercritical fluid exhibits both gas-like and liquid-like properties. The density of the supercritical fluid may be similar to that of a very dense gas and its diffusivity may be similar to diffusivities normally associated with gases, while its solubility properties may be similar to that of a liquid. Hence, a fluid in the supercritical state is sometimes described as having the behavior of a very mobile liquid, in which the solubility behavior approaches that of the liquid phase while penetration into a solid matrix is facilitated by the gas-like transport properties. Supercritical fluids will exhibit these properties as long as they are maintained in their supercritical range. However, when either the temperature or the pressure of a supercritical fluid drops below its associated critical point, the fluid is no longer classified as a supercritical fluid, because it no longer posses some or all of the mixed property characteristics associated with a substance in this range.

Supercritical fluids are used to extract various components from a wide variety of materials in a process commonly known as supercritical extraction. In some cases, the solubility of various components in a supercritical fluid is enhanced by the addition of a substance known as a cosolvent. The volatility of this additional component is usually intermediate that of the supercritical fluid and the substance to be extracted and/or to be imbibed.

Supercritical fluids have been used in various applications including food processing and parts cleaning. Their high solubilities and diffusivities make them an attractive choice for these applications.

Carbon dioxide, is one example of a substance that may be manipulated and placed into its supercritical range. Carbon dioxide is an attractive choice for use as a supercritical fluid. It is an abundant non-toxic material that exhibits a high level of solubility when placed in this supercritical range.

The in-situ delivery of therapeutic within a body of a patient is common in the practice of modern medicine. This in-situ delivery is often completed with coated medical devices that may be temporarily or permanently placed at a target site within the body. These medical devices can be maintained, as required, at their target sites for short and prolonged periods of time, in order to deliver therapeutic to the target site. These medical devices may be coated with a therapeutic or a combination of a therapeutic and a carrier material. Once placed within the body, the therapeutic may be released from the medical device into the target area and, thus, may be able to treat the targeted area. Examples of medical devices that may be coated with therapeutic for delivery to a target site include: vena-cava filters, aneurysm coils, stent-grafts, a-v shunts, angio-catheters, PICCs (Peripherally-inserted Central Catheters), stents, catheters, micro-particles, probes, sutures, staples, vascular grafts, screws, spinal fixation devices, pacing leads, bone engineered scaffolds, and tissue engineered scaffolds.

Supercritical fluids have also been used in applying bioactive agents and polymers to medical devices. The properties of supercritical fluids provide ideal conditions for bioactive agents that would otherwise be difficult to apply on the surface of a medical device without the aid of a polymeric material that may not be ideal for use on the device.

### SUMMARY OF THE INVENTION

Described herein are implantable medical devices that can be coated with polymers and/or bioactive agents with the aid of supercritical fluids (SCF) and methods for coating the devices. The medical devices described herein can have at least a portion of their surface made of or formed from a porous material. The SCFs are used as a carrier for the bioactive agents described. Once the bioactive agents are carried to the medical device surface, they are sequestered there, and migrate into the pores. The SCF is sprayed onto the medical devices. If appropriate conditions are used in the area of precipitation, bioactive agents can penetrate into the pores of the medical device before coming out of solution and expanding. Expanding the bioactive agent and filling the pores can achieve high loading of medical devices with bioactive agent as compared to a non-porous medical device.

Described herein is a method of applying at least one bioactive agent to a porous surface comprising the steps of providing an appropriate supercritical fluid; providing at least one bioactive agent; providing a medical device with a least a portion of the surface comprising a porous material; pressurizing said supercritical fluid to a pressure above the supercritical pressure of said supercritical fluid thereby forming a pressurized supercritical fluid; heating said pressurized supercritical fluid to a temperature above the supercritical temperature of said supercritical fluid thereby forming a supercritical fluid in the supercritical state; mixing said supercritical fluid in the supercritical state and said at least one bioactive agent thereby forming a supercritical mixture; placing the medical device in a chamber with ambient conditions below the supercritical fluids supercritical pressure and supercritical temperature; and spraying the device with the supercritical mixture thereby precipitating the bioactive agent within the pores on said porous surface thereby loading the medical device with the bioactive agent.

In one embodiment, the supercritical fluid is selected from the group consisting of carbon dioxide, acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon. In one embodiment, the supercritical fluid is carbon dioxide.

In one embodiment, the pressure below the supercritical pressure of the supercritical fluid is less than 73.2 bars. In another embodiment, the temperature above the supercritical temperature of the supercritical fluid is less than 31.3° C.

In one embodiment, the at least one bioactive agent is selected from macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

In one embodiment, the medical device is selected from the group consisting of stents, catheters, micro-particles, probes, sutures, staples, vascular grafts, screws, spinal fixation devices, pacing leads, bone engineered scaffolds, and tissue engineered scaffolds.

In one embodiment, the porous material is comprises nanopores. In another embodiment, the porous material is comprises a matrix.

Also described herein is a method of applying at least one bioactive agent and at least one polymeric material to a porous surface comprising the steps of providing an appropriate supercritical fluid; providing at least one bioactive agent; providing at least one polymeric material; providing a medical device with a least a portion of the surface comprising a porous material; pressurizing said supercritical fluid to a pressure above the supercritical pressure of said supercritical fluid thereby forming a pressurized supercritical fluid; heating said pressurized supercritical fluid to a temperature above the supercritical temperature of said supercritical fluid thereby forming a supercritical fluid in the supercritical state; mixing said supercritical fluid in the supercritical state and said at least one bioactive agent thereby forming a supercritical mixture; placing the medical device in a chamber with ambient conditions below the supercritical fluids supercritical pressure and supercritical temperature; and spraying the device with said supercritical mixture thereby expanding the bioactive agent within the pores on the porous surface thereby loading the medical device with the bioactive agent.

In one embodiment, the supercritical fluid is selected from the group consisting of carbon dioxide, acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon. In another embodiment, the supercritical fluid is carbon dioxide.

In one embodiment, the pressure above the supercritical pressure of the supercritical fluid is less than 73.2 bars. In another embodiment, the temperature above the supercritical temperature of the supercritical fluid is less than 31.3° C.

In one embodiment, the at least one bioactive agent is selected from macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

In one embodiment, the medical device is selected from the group consisting of stents, catheters, micro-particles, probes, sutures, staples, vascular grafts, screws, spinal fixation devices, pacing leads, bone engineered scaffolds, and tissue engineered scaffolds.

In one embodiment, the porous material is comprises nanopores. In one embodiment, the at least one polymeric material is selected from the group consisting of poly(L-lactic acid), polycaprolactone, poly(lactide-co-glycolide), poly(ethylene-vinyl acetate), poly(hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(aminoacids), cyanoacrylates, poly(trimethylene carbonate), poly(iminocarbonate), copoly(ether-esters), polyalkylene oxalates, polyphosphazenes, fibrin, fibrinogen, cellulose, starch, collagen, hyaluronic acid, polyurethanes, silicones, polyesters, polyolefins, polyisobutylene and ethylene-alphaolefin copolymers, acrylic polymers, ethylene-co-vinylacetate, polybutylmethacrylate, vinyl halide polymers, polyvinyl ethers, polyvinylidene halides, polyacrylonitrile, polyvinyl ketones, polyvinyl aromatics, polyvinyl esters, ethylene-methyl methacrylate copolymers, acrylonitrile-styrene copolymers, ABS resins, ethylene-vinyl acetate copolymers, polyamides, alkyd resins, polycarbonates, polyoxymethylenes, polyimides, polyethers, epoxy resins, polyurethanes, rayon, rayon-triacetate, cellulose, cellulose acetate, cellulose butyrate, cellulose acetate butyrate, cellophane, cellulose nitrate, cellulose propionate, cellulose ethers, carboxymethyl cellulose and combinations thereof.

Also described herein is a method of applying at least one bioactive agent to a porous surface comprising the steps of providing an appropriate supercritical fluid; providing at least one bioactive agent; providing a medical device with a least a portion of the surface comprising a porous material; pressurizing said supercritical fluid to a pressure above the supercritical pressure of said supercritical fluid thereby forming a pressurized supercritical fluid; heating said pressurized supercritical fluid to a temperature above the supercritical temperature of said supercritical fluid thereby forming a supercritical fluid in the supercritical state; mixing said supercritical fluid in the supercritical state and said at least one bioactive agent thereby forming a supercritical mixture; placing the medical device in a chamber with ambient conditions above the supercritical fluids supercritical pressure and supercritical temperature; introducing the supercritical mixture into said chamber; mixing and distributing the supercritical mixture in the chamber; and cooling the medical device thereby precipitating said bioactive agent thereby loading the medical device with the bioactive agent.

In one embodiment, the supercritical fluid is selected from the group consisting of carbon dioxide, acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon.

In another embodiment, the at least one bioactive agent is selected from macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

In one embodiment, the medical device is selected from the group consisting of stents, catheters, micro-particles, probes, sutures, staples, vascular grafts, screws, spinal fixation devices, pacing leads, bone engineered scaffolds, and tissue engineered scaffolds.

### BRIEF DESCRIPTION OF THE DRAWINGS

FIG. 1 is a schematic of a system according to the present description.

FIG. 2 is a schematic of the nozzle system used to spray medical devices.

FIG. 3 is a schematic of a system to precipitate SCF onto a medical device.

### DEFINITION OF TERMS

Bioactive Agent: As used herein “bioactive agent” shall include any drug, pharmaceutical compound or molecule having a therapeutic effect in an animal. Exemplary, non-limiting examples include anti-proliferatives including, but not limited to, macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

Exemplary FKBP 12 binding compounds include sirolimus (rapamycin), tacrolimus (FK506), everolimus (certican or RAD-001), temsirolimus (CCI-779 or amorphous rapamycin 42-ester with 3-hydroxy-2-(hydroxymethyl)-2-methylpropionic acid) and zotarolimus (ABT-578). Additionally, and other rapamycin hydroxyesters may be used in combination with the polymers described herein.

Biocompatible: As used herein “biocompatible” shall mean any material that does not cause injury or death to the animal or induce an adverse reaction in an animal when placed in intimate contact with the animal's tissues.

Biodegradable: As used herein “biodegradable” refers to a material composition that is biocompatible and subject to being broken down in vivo through the action of normal biochemical pathways. From time-to-time bioresorbable and biodegradable may be used interchangeably, however they are not coextensive. Biodegradable materials may or may not be reabsorbed into surrounding tissues, however, all bioresorbable materials are considered biodegradable. Biodegradable polymers, for example, are capable of being cleaved into biocompatible byproducts through chemical- or enzyme-catalyzed hydrolysis.

Nonbiodegradable: As used herein “nonbiodegradable” refers to a material composition that is biocompatible and not subject to being broken down in vivo through the action of normal biochemical pathways.

Not Substantially Toxic: As used herein “not substantially toxic” shall mean systemic or localized toxicity wherein the benefit to the recipient is out-weighted by the physiologically harmful effects of the treatment as determined by physicians and pharmacologists having ordinary skill in the art of toxicity.

Pharmaceutically Acceptable: As used herein “pharmaceutically acceptable” refers to all derivatives and salts that are not substantially toxic at effective levels in vivo.

### DETAILED DESCRIPTION OF THE INVENTION

Described herein are implantable medical devices that can be coated with polymers and/or bioactive agents with the aid of supercritical fluids (SCF) and methods for coating the devices. The medical devices described herein can have at least a portion of their surface made of or formed from a porous material or comprise a porous matrix. The SCFs are used as a carrier for the bioactive agents described. Once the bioactive agents are carried to the medical device surface, they are sequestered there, and migrate into the pores. The SCF is sprayed onto the medical devices. If appropriate conditions are used in the area of precipitation, bioactive agents can penetrate into the pores of the medical device before coming out of solution or precipitating. Expanding the bioactive agent and filling the pores can achieve high loading of medical devices with bioactive agent as compared to a non-porous medical device.

The medical devices described herein may be permanent medical implants, temporary implants, or removable devices. For example, and not intended as a limitation, the medical devices may include stents, catheters, micro-particles, probes, sutures, staples, vascular grafts, screws, spinal fixation devices, pacing leads, bone engineered scaffolds, and tissue engineered scaffolds.

In one embodiment, stents may be used as a drug delivery platform. The stents may be vascular stents, urethral stents, biliary stents, or stents intended for use in other ducts and organ lumens. Vascular stents, for example, may be used in peripheral, neurological, or coronary applications. The stents may be rigid expandable stents or pliable self-expanding stents. Any biocompatible material may be used to fabricate stents, including, without limitation, metals and polymers. The stents may also be biodegradable. In one embodiment, vascular stents are implanted into coronary arteries immediately following angioplasty. In another embodiment, vascular stents are implanted into the abdominal aorta to treat an abdominal aneurysm.

The medical devices described herein have at least a portion of their surface covered by a porous material. The porous surface can be formed within the material making up the device or in a coating deposited on the device surface, or a portion thereof. Various embodiments are contemplated wherein different portions of the medical devices are porous, to what degree and to what size pores. Pores may be any size pore conceivable by one skilled in the art. The pores are more preferably micropores or nanopores.

Nanoporous surfaces have unique physical properties. One important aspect is that a very high surface area to volume ratio can be achieved, rendering the surface capable of high amounts of drug loading. Controlling the sizes of the nanopores enables the practitioner to control the drug release rate and type of drug to be released into the physiological environment.

Nanopores include surface nanopores (i.e., nanopores that extend to the surface) or sub-surface nanopores (i.e., nanopores that do not extend to the surface, unless, for example, it does so via interconnection with surface pores). In this regard, in certain embodiments, nanopores are interconnected with each other, enhancing the ability of the nanoporous material to be used as a reservoir for the storage and delivery of bioactive agents. A nanoporous matrix can also be within the scope of the present description. The matrix can be formed by any means commonly known in the art.

Nanopores or nanostructures can be defined by their physical structures. A nanopore is a structure possessing dimensions less than 10 μm, preferably less than 5 μm, more preferably less than 1 μm in one or more axis. Axis include length, width, height and radius to name a few.

Nanoporous materials commonly have very high surface areas associated with them. For example, it is noted that nanoporous surfaces have significantly higher surface areas as compared to corresponding flat projected surfaces. This increase in surface area can be capitalized on in various ways. For example, in some embodiments, bioactive agents are bound or adsorbed to a nanoporous surface, thereby providing higher availability of the bioactive agent at the medical device surface than is obtained with a polished non-textured surface.

It is also noted that nanoporous regions have various characteristics that are driven by surface area. In this regard, as pore diameters reach nanometer-size dimensions, the surface area of the pores can become significant with respect to the volume of the pores. As the diameter of the pore approaches the diameter of the agent to be delivered, the surface interactions can dominate release rates. Furthermore, the amount of bioactive agent released and the duration of that release can also be affected by the depth and tortuousity of the nanopores within the nanoporous surface.

Hence, using the above and other techniques, nanostructured regions can be formed from a wide range of materials, including suitable materials selected from the metals, ceramics and polymers listed below.

Suitable materials include, but are not limited to, calcium phosphate ceramics (e.g., hydroxyapatite); calcium-phosphate glasses, sometimes referred to as glass ceramics (e.g., bioglass); metal oxides, including non-transition metal oxides (e.g., oxides of metals from groups 13, 14 and 15 of the periodic table, including, for example, aluminum oxide) and transition metal oxides (e.g., oxides of metals from groups 3, 4, 5, 6, 7, 8, 9, 10, 11 and 12 of the periodic table, including, for example, oxides of titanium, zirconium, hafnium, tantalum, molybdenum, tungsten, rhenium, iridium, and so forth); and carbon based ceramic-like materials such as silicon carbides and carbon nitrides.

Suitable metals include, but are not limited to, silver, gold, platinum, palladium, iridium, osmium, rhodium, titanium, tungsten, magnesium and ruthenium and metal alloys such as cobalt-chromium alloys, nickel-titanium alloys (e.g., nitinol), iron-chromium alloys (e.g., stainless steels, which contain at least 50% iron and at least 11.5% chromium), cobalt-chromium-iron alloys (e.g., elgiloy alloys), and nickel-chromium alloys (e.g., inconel alloys), among others.

Selection of an appropriate material for an implantable medical device can be accomplished by one skilled in the art. The material should be one that is biocompatible within the tissue it is being implanted in and possess the ability to accommodate the bioactive agent(s) that will be dispensed thereon or therein.

Structures such as hypotubes which are described in Ser. No. 11/780,702, which is incorporated herein by reference, may also be coated and or filled with bioactive agents and/or polymers according to the present description.

The selection of an appropriate SCF can be accomplished by one skilled in the art. Commonly used SCFs include acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon, among others.

Each SCF used will have a unique set of properties at different temperatures and pressures. The properties of the SCFs used can be adjusted to match the specific needs of the bioactive agent and/or polymers to be coated onto a device. Properties such as polarity, viscosity, and diffusivity can be altered by simply varying the temperature or pressure of the SCF.

Carbon dioxide is an attractive choice for use as a SCF. It is an abundant, non-toxic, non-flammable material that exhibits a high level of solubility when placed in its supercritical range. It also allows the processing of thermolabile compounds due to its critical temperature, behaves like a hydrocarbon solvent, can be used as a solvent or an antisolvent, possesses high diffusion constants compared to conventional organic solvents, it is non-reactive, easily recoverable, and it is inexpensive. However, carbon dioxide is but is one example of various substances that placed into its supercritical range.

The medical devices described herein comprise at least one bioactive agent to be delivered via the SCF. Exemplary, non limiting examples of bioactive agents useful herein include anti-proliferatives including, but not limited to, macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and the like.

Exemplary FKBP-12 binding agents include sirolimus (rapamycin), tacrolimus (FK506), everolimus (certican or RAD-001), temsirolimus (CCI-779 or amorphous rapamycin 42-ester with 3-hydroxy-2-(hydroxymethyl)-2-methylpropionic acid as disclosed in U.S. patent application Ser. No. 10/930,487) and zotarolimus (ABT-578; see U.S. Pat. Nos. 6,015,815 and 6,329,386). Additionally, other rapamycin hydroxyesters as disclosed in U.S. Pat. No. 5,362,718 may be used.

The effective amount of a bioactive agent used or coated on a medical device can be determined by a titration process. Titration is accomplished by preparing a series of medical device sets, stents can be sued as a non-limiting example. Each stent set will be coated, or contain different dosages of bioactive agent. The highest concentration used will be partially based on the known toxicology of the bioactive agent. The maximum amount of bioactive agent delivered by the stents will fall below known toxic levels. The dosage selected for further studies will be the minimum dose required to achieve the desired clinical outcome.

In addition to bioactive agents, a polymer may be admixed with the bioactive agent in the supercritical fluid to be applied to the medical device. Additionally, a polymer can be coated onto the device as a primer, e.g. parylene, prior to delivering the bioactive agent in the supercritical fluid solution. Likewise, a top coat polymer, e.g. polycaprolactone, can be applied following the delivery of the bioactive agent in the supercritical fluid solution. Deposition of both the primer and/or top coat can be performed using either standard coating processes or via supercritical solution delivery as described herein.

In one embodiment, the polymer chosen must be a polymer that is biocompatible and minimizes irritation to the vessel wall when the medical device is implanted. The polymer may be either a biostable or a biodegradable polymer depending on the desired rate of release or the desired degree of polymer stability. Biodegradable polymers that can be used include poly(L-lactic acid), polycaprolactone, poly(lactide-co-glycolide), poly(ethylene-vinyl acetate), poly(hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(amino acids), cyanoacrylates, poly(trimethylene carbonate), poly(iminocarbonate), copoly(ether-esters) (e.g. PEO/PLA), polyalkylene oxalates, polyphosphazenes and biomolecules such as fibrin, fibrinogen, cellulose, starch, collagen and hyaluronic acid.

Also, biostable polymers with a relatively low chronic tissue response such as polyurethanes, silicones, and polyesters could be used. Other polymers such as polyolefins, polyisobutylene and ethylene-alphaolefin copolymers; acrylic polymers and copolymers, ethylene-co-vinylacetate, polybutylmethacrylate, vinyl halide polymers and copolymers, such as polyvinyl chloride; polyvinyl ethers, such as polyvinyl methyl ether; polyvinylidene halides, such as polyvinylidene fluoride and polyvinylidene chloride; polyacrylonitrile, polyvinyl ketones; polyvinyl aromatics, such as polystyrene, polyvinyl esters, such as polyvinyl acetate; copolymers of vinyl monomers with each other and olefins, such as ethylene-methyl methacrylate copolymers, acrylonitrile-styrene copolymers, ABS resins, and ethylene-vinyl acetate copolymers; polyamides, such as Nylon 66 and polycaprolactam; alkyd resins; polycarbonates; polyoxymethylenes; polyimides; polyethers; epoxy resins, polyurethanes; rayon; rayon-triacetate; cellulose, cellulose acetate, cellulose butyrate; cellulose acetate butyrate; cellophane; cellulose nitrate; cellulose propionate; cellulose ethers; and carboxymethyl cellulose could also be used if they can be dissolved and cured or polymerized on the medical device.

The medical devices formed as discussed herein may be designed with a specific dose of bioactive agent. That dose may be a specific weight of bioactive agent added or a bioactive agent to polymer ratio. In one embodiment, the medical device can be loaded with 1 to 1000 μg of bioactive agent; in another embodiment, 5 μg to 500 μg; in another embodiment 10 μg to 250 μg; in another embodiment, 15 μg 150 μg. A ratio may also be established to describe how much bioactive agent is added to the polymer that is added to the supercritical fluid to be coated onto the medical device or formed or coated into or onto the medical device without the aid of supercritical fluid. In one embodiment a ratio of 1 part bioactive agent: 1 part polymer may be used; in another embodiment, 1:1-5; in another embodiment, 1:1-9; in another embodiment, 1:1-20.

Rapid expansion of supercritical solution (RESS) is one method of depositing the bioactive agents using SCF. In one embodiment, RESS is utilized to apply bioactive agents described herein. The RESS process is utilized by dissolving the bioactive agent(s) in the supercritical fluid under sub or supercritical conditions. Once the bioactive agent(s) are in solution, they can be applied to the surface of a medical device. In the present description, the medical device can have regions of porous material wherein the supercritical fluid including the bioactive agent(s) can be applied. After the supercritical material has been applied to the porous surface, the temperature and/or pressure can be lowered thereby returning the fluid to a non-supercritical state. Upon changing the temperature and pressure to below supercritical conditions, the fluid and its contents will rapidly expand and in certain cases precipitate. The bioactive agents will expand and precipitate within the nanopores on the surface of the device, thereby loading the pores with bioactive agent.

The supercritical fluid including the bioactive agent(s) possesses a viscosity that is less than that of more traditional solvent carrying systems. Traditional solvent systems such as chloroform/dichloromethane/ethanol do not possess sufficiently low viscosity to allow ideal penetration of bioactive agent(s) and/or polymers into micro and/or nanopores. The supercritical fluid loading of bioactive agent(s) into the micro and/or nanopores can alleviate the need for a polymer coating or system to control the release of the bioactive agent(s). Additionally, since large polymer systems or macromers may not be required for the implantable medical devices, the need to dissolve them in the supercritical fluid, a limitation of the supercritical process may not be required.

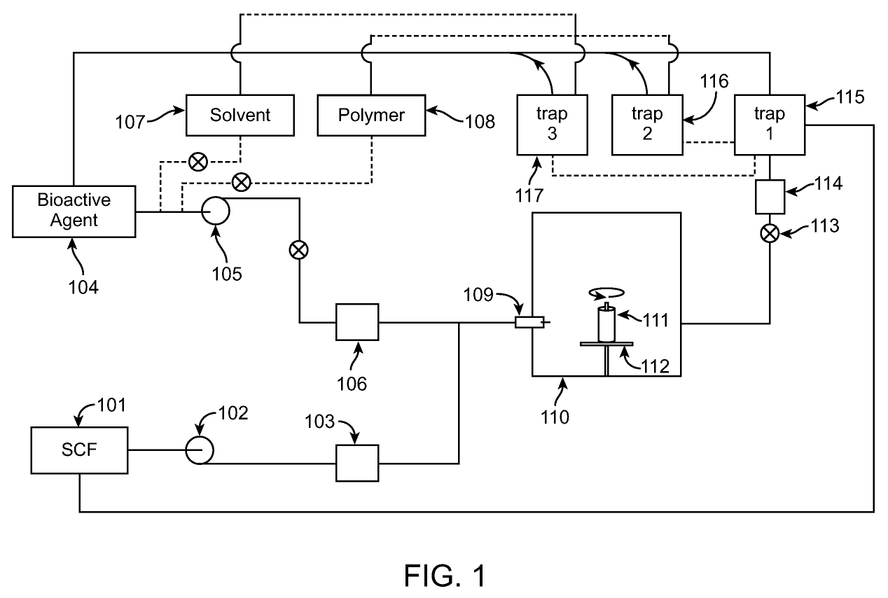

One specific embodiment is shown in FIG. 1 wherein stents having nanoporous surface regions are loaded with a bioactive agent using SCF as a carrier. Referring now to FIG. 1, a SCF source 101 provides the SCF to the system. The SCF from source 101 passes through first pump 102, to a region having a pressure that is above the critical pressure of the SCF. The stream containing the SCF is heated to a temperature that is above the critical temperature using heater 103. The solvent, at this point is in the supercritical realm.

The SCF stream is joined by a stream of biologically active agent from source 104, which is pumped to the same pressure and temperature as the SCF stream via second pump 105 and second heater 106. If desired, the biologically active agent can be dissolved or provided as a colloidal suspension in a cosolvent. The SCF and bioactive agent can be mixed with a solvent from source 107 and/or a polymer from source 108 via pump 105.

The supercritical mixture is pumped through nozzle 109 and sprayed into chamber 110 and onto medical device 111. The medical device being coated is located on a platform 112 that can be rotated to ensure proper coverage of the device. In chamber 110, the supercritical mixture penetrates the nanoporous surface regions of the medical devices, for example, due to the gas-like transport properties of the supercritical mixture.

After exposure to the medical device 111, the supercritical mixture passes through valve 113, evaporator 114 and can begin the recycling process. Trap 1 (115) and optionally trap 2 (116) and 3 (117) can separate out it respective component of the supercritical mixture. Trap 115 can separate the SCF from the rest of the mixture. Traps 116 and 117 can be employed to separate any polymers or solvents from the bioactive agent.

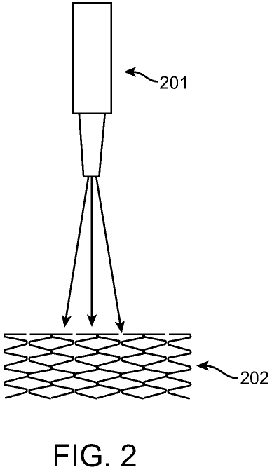

FIG. 2 depicts a non-limiting example of a nozzle configuration according to the present description. Nozzle 201 is maintained above supercritical conditions thereby keeping the bioactive agent or bioactive agent and polymer and/or co-solvent dissolved in the SCF. Medical device 202 can be positioned at an optimum location which is determined by the operator. The chamber the medical device 202 and nozzle 201 are located in can be held at conditions slightly below supercritical conditions which can causes the bioactive agent or bioactive agent and polymer and/or co-solvent to come out of solution slowly during the process. The conditions of the chamber can be critical to the spraying process. A pressure or temperature too low and the dissolved species may come out of solution too quickly. A pressure and/or temperature too high and the dissolved species may come out of solution too slowly or desolated species may re-dissolve into solution.

In certain embodiments of the invention, deposition and/or precipitation of the biologically active agent is influenced by controlling the rate at which the carrier fluid is removed from the chamber. For example, deposition and/or precipitation of the biologically active agent may be increased by reducing the rate at which the carrier fluid is bled from the chamber.

In one embodiment, a stream containing the SCF without biologically active agents is sprayed onto the medical device to remove biologically active agents that have been deposited in excess of the desired target quantities. In another embodiment, the stream of SCF without biologically active agents is used to remove biologically active agents that have deposited in anomalous configurations.

FIG. 1 describes an apparatus and process in which SCF is used to load medical devices with a biologically active agent and optionally a polymer. Any combination of SCF, polymer, solvent and bioactive agent described herein or known by those skilled in the art are considered within the scope of the present description.

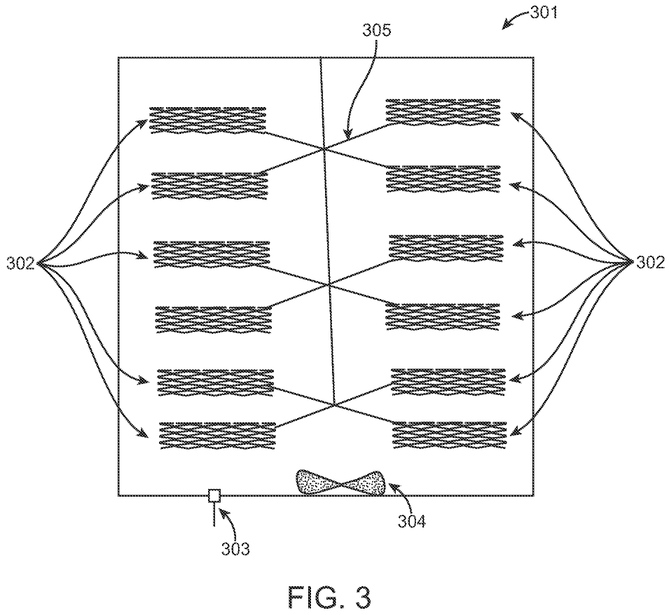

In another embodiment, the bioactive agent and optional polymer(s) and/or co-solvent(s) can be deposited on a medical device without directly spraying the SCF at the medical device. FIG. 3 depict chamber 301 wherein the pressure and temperature is kept above supercritical conditions, thereby keeping the bioactive agent and optional polymer(s) and/or co-solvent(s) dissolved in the SCF. Multiple medical devices can be laoded into the chamber thereby allowing the coating of multiple medical devices in a single batch. Medical device(s) 302 are loaded into chamber 301 and the chamber is brought to a temperature and pressure above supercritical conditions. The supercritical fluid is introduced into the chamber by nozzle 303 which can be located anywhere within the chamber. Mixing device 304 mixes and distributes the SCF throughout the chamber. Once the SCF is uniformly mixed in the chamber, the medical device(s) 302 are cooled to a temperature below supercritical temperature by cooling line(s) 305. As the medical devices are cooled, the bioactive agent and optional polymer(s) will precipitate into the medical device(s).

The system depicted in FIG. 3 can also be used to recover and/or reuse bioactive agents, polymers and/or co-solvents not deposited during the loading process. These constituents can be used in subsequent coating batches.

Chamber conditions can be very critical in the present process. Even slight deviations in temperature or pressure can cause precipitation, leeching of the bioactive agent, or evaporation of the supercritical fluid. It is important to determine the appropriate conditions for a given bioactive agent (or set of bioactive agents) and supercritical fluid of choice. One skilled in the art can accomplish this with little difficulty. Changes in pressure and/or temperature can also be used to more effectively trap bioactive agents in the pores of medical devices. A more rapid decrease in temperature can cause rapid precipitation of the bioactive agent thereby trapping it in the pores. The same can be said for decreasing the pressure. Additionally, if the temperature and or pressure are raised, one can re-dissolve the bioactive agent in the supercritical fluid. Either technique can be used by a skilled practitioner to accomplish proper loading of the pores with bioactive agent(s).

The steps of coating described herein can be performed in several different orders to achieve different coating conditions. Additionally, certain steps may be skipped or removed from the process. Any combination of additional steps, repeated steps, removed steps and skipped steps are within the realm of the present disclosure.

### EXAMPLE 1

Carbon dioxide is provided and will be used as the supercritical fluid. The bioactive agent will be zotarolimus. A stainless steel stent with a nanoporous surface is provided and cleaned. The stent placed a glass beaker and covered with reagent grade or better hexane. The beaker containing the hexane immersed stent was then placed into an ultrasonic water bath and treated for 15 minutes at a frequency of between approximately 25 to 50 KHz. Next the stent is removed from the hexane and the hexane is discarded. The stent is then immersed in reagent grade or better 2-propanol and vessel containing the stent and the 2-propanol was treated in an ultrasonic water bath as before. Following cleaning the stent with organic solvents, it is thoroughly washed with distilled water and thereafter immersed in 1.0 N sodium hydroxide solution and treated at in an ultrasonic water bath as before. Finally, the stent is removed from the sodium hydroxide, thoroughly rinsed in distilled water and then dried in a vacuum oven over night at 40° C. After cooling the dried stent to room temperature in a desiccated environment it is weighed and its weights were recorded.

The carbon dioxide is pumped to a pressure of 74 bars, just above its supercritical pressure. The carbon dioxide is then heated to a temperature of 32° C., a temperature just above its supercritical temperature. The zotarolimus is mixed and dissolved in the carbon dioxide forming a mixture. The mixture is now a supercritical fluid mixture.

The stent is placed on a revolving holder within a temperature and pressure controlled chamber. The chamber is held at a constant temperature just below 32° C. and a pressure just below 74 bars. The stent is spun with the revolving holder and the supercritical fluid mixture is sprayed at the stent. As the stent revolves, the supercritical fluid mixture coats the different parts of the device that pass in front of the nozzle.

The conditions of the chamber can be adjusted to allow appropriate migration of the bioactive agent into the pores of the stent's surface. Residual supercritical fluid mixture can be separated and recycled. The stent is now coated and can be washed or processed accordingly, including polymer cap coatings, or any other appropriate process step.

### EXAMPLE 2

Carbon dioxide is provided and will be used as the supercritical fluid. The bioactive agent will be zotarolimus. Polycaprolactone (PCL) is used as a polymer for co-administration with the zotarolimus. A stainless steel stent with a nanoporous surface is provided and cleaned according to Example 1.

The carbon dioxide is pumped to a pressure of 74 bars, just above its supercritical pressure. The carbon dioxide is then heated to a temperature of 32° C., a temperature just above its supercritical temperature. The zotarolimus and PCL are mixed and dissolved in the carbon dioxide forming a mixture. The mixture is now a supercritical fluid mixture.

The stent is sprayed with the supercritical fluid mixture as in Example 1.

The conditions of the chamber can be adjusted to allow appropriate migration of the zotarolimus and PCL into the pores of the stent's surface. PCL can also sequester on the surface of the stent thereby forming a coating. Residual supercritical fluid mixture can be separated and recycled. The stent is now coated and can be washed or processed accordingly, including polymer cap coatings, or any other appropriate process step.

### EXAMPLE 3

Carbon dioxide is provided and will be used as the supercritical fluid. The bioactive agent will be zotarolimus. A stainless steel stent with a nanoporous surface is provided and cleaned according to Example 1.

The carbon dioxide is pumped to a pressure of 74 bars, just above its supercritical pressure. The carbon dioxide is then heated to a temperature of 32° C., a temperature just above its supercritical temperature. The zotarolimus is mixed and dissolved in the carbon dioxide forming a mixture. The mixture is now a supercritical fluid mixture.

Multiple stents are placed on a holder in a temperature and pressure controlled chamber. The chamber is held at a constant temperature just above 32° C. and a pressure just above 74 bars. The supercritical fluid introduced into the chamber and allowed to uniformly mix within the chamber. The stents are cooled to a temperature below 32° C. and the zotarolimus precipitates onto the device.

### EXAMPLE 4

Carbon dioxide is provided and will be used as the supercritical fluid. The bioactive agent will be zotarolimus. Polycaprolactone (PCL) is used as a polymer for co-administration with the zotarolimus. A stainless steel stent with a nanoporous surface is provided and cleaned according to Example 1.

The carbon dioxide is pumped to a pressure of 74 bars, just above its supercritical pressure. The carbon dioxide is then heated to a temperature of 32° C., a temperature just above its supercritical temperature. The zotarolimus and PCL are mixed and dissolved in the carbon dioxide forming a mixture. The mixture is now a supercritical fluid mixture.

Multiple stents are placed on a holder in a temperature and pressure controlled chamber. The chamber is held at a constant temperature just above 32° C. and a pressure just above 74 bars. The supercritical fluid mixture introduced into the chamber and allowed to uniformly mix within the chamber. The stents are cooled to a temperature below 32° C. and the zotarolimus and PCL precipitate onto the device.

Unless otherwise indicated, all numbers expressing quantities of ingredients, properties such as molecular weight, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing the invention (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

Certain embodiments of this invention are described herein, including the best mode known to the inventors for carrying out the invention. Of course, variations on these described embodiments will become apparent to those of ordinary skill in the art upon reading the foregoing description. The inventor expects skilled artisans to employ such variations as appropriate, and the inventors intend for the invention to be practiced otherwise than specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

Furthermore, numerous references have been made to patents and printed publications throughout this specification. Each of the above-cited references and printed publications are individually incorporated herein by reference in their entirety.

In closing, it is to be understood that the embodiments of the invention disclosed herein are illustrative of the principles of the present invention. Other modifications that may be employed are within the scope of the invention. Thus, by way of example, but not of limitation, alternative configurations of the present invention may be utilized in accordance with the teachings herein. Accordingly, the present invention is not limited to that precisely as shown and described.

I claim:

1. A method of applying at least one bioactive agent to a porous surface comprising the steps:
providing an appropriate supercritical fluid;
providing at least one bioactive agent;
providing a medical device with a least a portion of the surface comprising a porous material;
pressurizing said supercritical fluid to a pressure above the supercritical pressure of said supercritical fluid thereby forming a pressurized supercritical fluid;
heating said pressurized supercritical fluid to a temperature above the supercritical temperature of said supercritical fluid thereby forming a supercritical fluid in the supercritical state;
mixing said supercritical fluid in the supercritical state and said at least one bioactive agent thereby forming a supercritical mixture;
placing said medical device in a chamber with ambient conditions below said supercritical fluids supercritical pressure and supercritical temperature; and
spraying said device with said supercritical mixture thereby precipitating said bioactive agent within the pores on said porous surface thereby loading said medical device with said bioactive agent.

2. The method according to claim 1 wherein said supercritical fluid is selected from the group consisting of carbon dioxide, acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon.

3. The method according to claim 2 wherein said supercritical fluid is carbon dioxide.

4. The method according to claim 3 wherein said pressure below the supercritical pressure of said supercritical fluid is less than 73.2 bars.

5. The method according to claim 3 wherein said temperature above the supercritical temperature of said supercritical fluid is less than 31.3° C.

6. The method according to claim 1 wherein said at least one bioactive agent is selected from macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

7. The method according to claim 1 wherein said medical device is selected from the group consisting of stents, catheters, micro-particles, probes, sutures, staples, vascular grafts, screws, spinal fixation devices, pacing leads, bone engineered scaffolds, and tissue engineered scaffolds.

8. The method according to claim 1 wherein said porous material is comprises nanopores.

9. The method according to claim 1 wherein said porous material is comprises a matrix.

10. A method of applying at least one bioactive agent and at least one polymeric material to a porous surface comprising the steps:
providing an appropriate supercritical fluid;
providing at least one bioactive agent;
providing at least one polymeric material;
providing a medical device with a least a portion of the surface comprising a porous material;
pressurizing said supercritical fluid to a pressure above the supercritical pressure of said supercritical fluid thereby forming a pressurized supercritical fluid;
heating said pressurized supercritical fluid to a temperature above the supercritical temperature of said supercritical fluid thereby forming a supercritical fluid in the supercritical state;
mixing said supercritical fluid in the supercritical state and said at least one bioactive agent thereby forming a supercritical mixture;
placing said medical device in a chamber with ambient conditions below said supercritical fluids supercritical pressure and supercritical temperature; and
spraying said device with said supercritical mixture thereby expanding said bioactive agent within the pores on said porous surface thereby loading said medical device with said bioactive agent.

11. The method according to claim 10 wherein said supercritical fluid is selected from the group consisting of carbon dioxide, acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon.

12. The method according to claim 10 wherein said supercritical fluid is carbon dioxide.

13. The method according to claim 12 wherein said pressure above the supercritical pressure of said supercritical fluid is less than 73.2 bars.

14. The method according to claim 12 wherein said temperature above the supercritical temperature of said supercritical fluid is less than 31.3° C.

15. The method according to claim 10 wherein said at least one bioactive agent is selected from macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

16. The method according to claim 10 wherein said medical device is selected from the group consisting of stents, catheters, micro-particles, probes, sutures, staples, vascular grafts, screws, spinal fixation devices, pacing leads, bone engineered scaffolds, and tissue engineered scaffolds.

17. The method according to claim 10 wherein said porous material is comprises nanopores.

18. The method according to claim 10 wherein said at least one polymeric material is selected from the group consisting of poly(L-lactic acid), polycaprolactone, poly(lactide-co-glycolide), poly(ethylene-vinyl acetate), poly(hydroxybutyrate-co-valerate), polydioxanone, polyorthoester, polyanhydride, poly(glycolic acid), poly(D,L-lactic acid), poly(glycolic acid-co-trimethylene carbonate), polyphosphoester, polyphosphoester urethane, poly(amino acids), cyanoacrylates, poly(trimethylene carbonate), poly(iminocarbonate), copoly(ether-esters), polyalkylene oxalates, polyphosphazenes, fibrin, fibrinogen, cellulose, starch, collagen, hyaluronic acid, polyurethanes, silicones, polyesters, polyolefins, polyisobutylene and ethylene-alphaolefin copolymers, acrylic polymers, ethylene-co-vinylacetate, polybutylmethacrylate, vinyl halide polymers, polyvinyl ethers, polyvinylidene halides, polyacrylonitrile, polyvinyl ketones, polyvinyl aromatics, polyvinyl esters, ethylene-methyl methacrylate copolymers, acrylonitrile-styrene copolymers, ABS resins, ethylene-vinyl acetate copolymers, polyamides, alkyd resins, polycarbonates, polyoxymethylenes, polyimides, polyethers, epoxy resins, polyurethanes, rayon, rayon-triacetate, cellulose, cellulose acetate, cellulose butyrate, cellulose acetate butyrate, cellophane, cellulose nitrate, cellulose propionate, cellulose ethers, carboxymethyl cellulose and combinations thereof.

19. A method of applying at least one bioactive agent to a porous surface comprising the steps:
providing an appropriate supercritical fluid;
providing at least one bioactive agent;
providing a medical device with a least a portion of the surface comprising a porous material;
pressurizing said supercritical fluid to a pressure above the supercritical pressure of said supercritical fluid thereby forming a pressurized supercritical fluid;
heating said pressurized supercritical fluid to a temperature above the supercritical temperature of said supercritical fluid thereby forming a supercritical fluid in the supercritical state;
mixing said supercritical fluid in the supercritical state and said at least one bioactive agent thereby forming a supercritical mixture;
placing said medical device in a chamber with ambient conditions above said supercritical fluids supercritical pressure and supercritical temperature;
introducing said supercritical mixture into said chamber;
mixing and distributing said supercritical mixture in said chamber; and
cooling said medical device thereby precipitating said bioactive agent thereby loading said medical device with said bioactive agent.

20. The method according to claim 19 wherein said supercritical fluid is selected from the group consisting of carbon dioxide, acetylene, ammonia, argon, carbon tetrafluoride, cyclohexane, dichlorodifluoromethane, ethane, ethylene, hydrogen, krypton, methane, neon, nitrogen, nitrous oxide, oxygen, pentane, propane, propylene, toluene, trichlorofluoromethane, trifluoromethane, trifluorochloromethane and xenon.

21. The method according to claim 19 wherein said at least one bioactive agent is selected from macrolide antibiotics including FKBP-12 binding compounds, estrogens, chaperone inhibitors, protease inhibitors, protein-tyrosine kinase inhibitors, leptomycin B, peroxisome proliferator-activated receptor gamma ligands (PPARγ), hypothemycin, nitric oxide, bisphosphonates, epidermal growth factor inhibitors, antibodies, proteasome inhibitors, antibiotics, anti-inflammatories, anti-sense nucleotides and transforming nucleic acids. Drugs can also refer to bioactive agents including anti-proliferative compounds, cytostatic compounds, toxic compounds, anti-inflammatory compounds, chemotherapeutic agents, analgesics, antibiotics, protease inhibitors, statins, nucleic acids, polypeptides, growth factors and delivery vectors including recombinant micro-organisms, liposomes, menadione, tipradane, halogenated aromatic phenoxy derivatives, atovaquone, fluconazole, propanolol, megestrol acetate, felodipine, benaodiapines, caffeine, vitamins, tocopherol acetate, polymyxin B sulfate, acylvoir, sulfamethazole, triamcinolone, misoprostol, veterinary drugs, codeine, morphine, flavone, ketorolac, mebervine alcohol, beudesonide, taxanes, herbal medicines, diosegenin, zingiber zerumbert rhizomes, mevinolin, phylloquinone, pseudoephedrine, steroids, ibuprofen and combinations thereof.

22. The method according to claim 19 wherein said medical device is selected from the group consisting of stents, catheters, micro-particles, probes, sutures, staples, vascular grafts, screws, spinal fixation devices, pacing leads, bone engineered scaffolds, and tissue engineered scaffolds.
